(19) United States
(12) Patent Application Publication
(10) Pub. No.: US 2006/0078794 A1
(43) Pub. Date: Apr. 13, 2006

(54) Nickel-metal hydride storage battery

(76) Inventors: Tetsuyuki Murata, Kobe-shi (JP); Shigekazu Yasuoka, Kobe-shi (JP); Yoshifumi Magari, Kobe-shi (JP); Tadayoshi Tanaka, Osaka (JP); Jun Ishida, Kobe-shi (JP)

Correspondence Address: KUBOVCIK & KUBOVCIK, SUITE 710, 900 17TH STREET NW, WASHINGTON, DC, 20006, US

(21) Appl. No.: 11/244,034

(22) Filed: Oct. 6, 2005

(30) Foreign Application Priority Data
Oct. 7, 2004 (JP) 2004-294407

(51) Int. Cl. H01M 4/58; H01M 4/62

(52) U.S. Cl. 429/218.2; 429/232

(57) ABSTRACT

Middle point voltage of discharge is increased and at the same time cycle life improved in a nickel-metal hydride storage battery having a negative electrode utilizing a rare earth-nickel hydrogen-absorbing alloy containing Mg and the like and having a crystal structure other than a CaCu₅ structure. A nickel-metal hydride storage battery contains a positive electrode (1), a negative electrode (2) including a hydrogen-absorbing alloy, and an alkaline electrolyte solution. The hydrogen-absorbing alloy contains at least a rare-earth element, magnesium, nickel, and aluminum, and has an intensity ratio I_{A}/I_{B} of 0.1 or greater as determined by X-ray diffraction analysis using Cu-Kα radiation as an X-ray source, where I_{A} is the strongest peak intensity that appears in the range of 20=30° to 34°, and I_{B} is the strongest peak intensity that appears in the range of 2θ=40° to 44°. The negative electrode contains a cobalt compound.

### BACKGROUND OF THE INVENTION

1. Field of the Invention

The present invention relates to a nickel-metal hydride storage battery comprising a positive electrode, a negative electrode employing a hydrogen-absorbing alloy, and an alkaline electrolyte solution. More particularly, a feature of the present invention is to enhance middle point voltage of discharge and improve the cycle life of a nickel-metal hydride storage battery having a negative electrode that contains at least a rare-earth element, magnesium, nickel, and aluminum and adopts a hydrogen-absorbing alloy having an intensity ratio I_{A}/I_{B} of 0.1 or greater as determined by X-ray diffraction analysis using Cu-Kα radiation as an X-ray source, where I_{A} is the strongest peak intensity that appears in the range 2θ=30° to 34° and I_{B} is the strongest peak intensity that appears in the range 2θ=40° to 44°.

2. Description of Related Art

In recent years, nickel-metal hydride storage batteries using a hydrogen-absorbing alloy as their negative electrode active material have drawn attention because they have high capacity and are advantageous in environmental safety among alkaline storage batteries.

As the nickel-metal hydride storage batteries have been used in various portable electronic devices, higher performance in the nickel-metal hydride storage batteries has been demanded.

In the nickel-metal hydride storage batteries, hydrogen-absorbing alloys such as a rare earth-nickel hydrogen-absorbing alloy having a CaCu₅ crystal structure as its main phase and a Laves phase hydrogen-absorbing alloy containing Ti, Zr, V and Ni have been commonly used for their negative electrodes.

However, problems with these hydrogen-absorbing alloys have been that they do not necessarily achieve sufficient hydrogen-absorbing capability, and that it is difficult to further increase the capacity of the nickel-metal hydride storage batteries.

In addition, a conventional nickel-metal hydride storage battery has been proposed, which has a negative electrode as described below. The negative electrode uses the above-noted rare earth-nickel hydrogen-absorbing alloy having a CaCu₅ crystal structure as its main phase. Cobalt or a cobalt compound is added to the negative electrode so that a cobalt layer is formed on the surface of the hydrogen-absorbing alloy by, for example, charging and discharging the negative electrode. Thereby, the catalytic activity in the negative electrode is improved by the cobalt layer and thus battery internal pressure is prevented from increasing. In another conventional technique that has been proposed, a conductive network is formed between hydrogen-absorbing alloy particles by cobalt or a cobalt oxide. (See, for example, Japanese Patent Nos. 2982521 and 3088133.)

In recent years, in order to enhance the hydrogen-absorbing capability of hydrogen-absorbing alloys and thereby increase the capacity of nickel-metal hydride storage batteries, a nickel-metal hydride storage battery has been proposed that adopts a negative electrode using a rare earth-nickel hydrogen-absorbing alloy containing Mg and the like and having a crystal structure other than the CaCu₅ crystal structure. (See, for example, Japanese Published Unexamined Patent Application No. 2001-316744.)

Nevertheless, a problem with the nickel-metal hydride storage battery having a negative electrode using a rare earth-nickel hydrogen-absorbing alloy containing Mg and the like and having a crystal structure other than the CaCu₅ crystal structure has been that the nickel-metal hydride storage battery tends to have a lower middle point voltage of discharge and shorter cycle life than a nickel-metal hydride storage battery having the negative electrode using the rare earth-nickel hydrogen-absorbing alloy having a CaCu₅ crystal structure as its main phase.

### BRIEF SUMMARY OF THE INVENTION

An issue addressed by the present invention is to resolve the foregoing and other problems of a nickel-metal hydride storage battery containing a negative electrode that uses a rare earth-nickel hydrogen-absorbing alloy having a crystal structure other than the CaCu₅ crystal structure, the hydrogen-absorbing alloy containing Mg and the like, in order to improve the hydrogen-absorbing capability of the hydrogen-absorbing alloy.

The present inventors have investigated the cause of cycle life degradation in a nickel-metal hydride storage battery adopting the above-described hydrogen-absorbing alloy. The reason is believed to be that the charge-discharge operation of the above-described nickel-metal hydride storage battery causes Mg contained in the hydrogen-absorbing alloy to dissolve into the alkaline electrolyte solution, thereby changing the composition of the hydrogen-absorbing alloy and deteriorating the hydrogen-absorbing alloy. Also, the dissolved Mg deposits on the surface of the hydrogen-absorbing alloy in the form of a magnesium compound such as magnesium oxide, magnesium hydroxide, or the like, which has low conductivity, thereby lowering the discharge performance of the hydrogen-absorbing alloy.

Accordingly, an object of the present invention is, with a nickel-metal hydride storage battery using the above-described hydrogen-absorbing alloy, to prevent the middle point voltage of discharge from decreasing and at the same time to improve the cycle life.

In order to resolve the foregoing and other problems, the present invention provides a nickel-metal hydride storage battery comprising: a positive electrode; a negative electrode including a hydrogen-absorbing alloy; and an alkaline electrolyte solution. The hydrogen-absorbing alloy contains at least a rare-earth element, magnesium, nickel, and aluminum, and has an intensity ratio I_{A}/I_{B} of 0.1 or greater as determined by X-ray diffraction analysis using Cu-Kα radiation as an X-ray source, where I_{A} is the strongest peak intensity that appears in the range of 2θ=30° to 34°, and I_{B} is the strongest peak intensity that appears in the range of 2θ=40° to 440. The negative electrode contains a cobalt compound.

The cobalt compound to be added to the negative electrode should preferably dissolve into the alkaline electrolyte solution and deposit on the surface of the hydrogen-absorbing alloy quickly. Usable examples include cobalt oxide and cobalt hydroxide, with cobalt oxide being particularly preferable. When adding a cobalt compound to the negative electrode, it is preferable that the amount of cobalt in the cobalt compound be within the range of from 0.3 to 0.8 weight % with respect to the weight of the hydrogen-absorbing alloy.

In the nickel-metal hydride storage battery according to the present invention, the hydrogen-absorbing alloy used for the negative electrode may be a hydrogen-absorbing alloy represented by the composition formula RE₁₋ₓMgₓNi_{y}Al_{z}Mₐ, wherein RE denotes rare-earth element(s), M is element(s) other than the rare-earth element(s), Mg, Ni, and Al, and the following conditions are satisfied: 0.10<x≦0.30, 2.8≦y≦3.6, 0+z≦0.30, and 3.0≦y+z+a≦3.6.

As described above, the present invention utilizes a hydrogen-absorbing alloy containing at least a rare-earth element, magnesium, nickel, and aluminum, and having an intensity ratio I_{A}/I_{B} of 0.1 or greater as determined by X-ray diffraction analysis using Cu-Kα radiation as an X-ray source, where I_{A} is the strongest peak intensity that appears in the range of 2θ=30° to 34°, and I_{B} is the strongest peak intensity that appears in the range of 2θ=40° to 44°, as the hydrogen-absorbing alloy in the nickel-metal hydride storage battery comprising a positive electrode, a negative electrode including a hydrogen-absorbing alloy, and an alkaline electrolyte solution. Therefore, the invention enables the nickel-metal hydride storage battery to have a higher capacity than the nickel-metal hydride storage battery using the rare earth-nickel hydrogen-absorbing alloy having a CaCu₅ crystal structure as its main phase.

Moreover, in the nickel-metal hydride storage battery according to the present invention, a cobalt compound is added to the negative electrode using the specified hydrogen-absorbing alloy. Therefore, by charging and discharging this nickel-metal hydride storage battery, the cobalt compound quickly dissolves into the alkaline electrolyte solution, causing the cobalt compound, which has a high conductivity, to deposit on the surface of the hydrogen-absorbing alloy. This prevents the magnesium contained in the hydrogen-absorbing alloy from dissolving into the alkaline electrolyte solution, and inhibits the composition of the hydrogen-absorbing alloy from changing and the hydrogen-absorbing alloy from deteriorating. Moreover, the cobalt compound deposited on the surface of the hydrogen-absorbing alloy, and which has high conductivity, serves to reduce the resistance in the negative electrode.

As a consequence, the nickel-metal hydride storage battery according to the present invention makes it possible to prevent the middle point voltage of discharge from decreasing and at the same time improve the cycle life, even when using the above-described hydrogen-absorbing alloy for the negative electrode.

When cobalt, not a cobalt compound, is added to the negative electrode using the above-described hydrogen-absorbing alloy, the magnesium contained in the hydrogen-absorbing alloy cannot be sufficiently prevented from dissolving into the alkaline electrolyte solution because cobalt dissolves slowly into the alkaline electrolyte solution during charging and discharging. Moreover, the cobalt may migrate from the negative electrode to the separator, causing micro short-circuits and consequent degradation in cycle life.

### BRIEF DESCRIPTION OF THE DRAWINGS

FIG. 1 is a schematic cross-sectional view of a nickel-metal hydride storage battery, as prepared in Examples 1 to 3 and Comparative Examples 1 and 2.

### DETAILED DESCRIPTION OF THE INVENTION

Hereinbelow, examples of the nickel-metal hydride storage battery according to the present invention are specifically described along with comparative examples, and it will be demonstrated that the examples of the nickel-metal hydride storage battery of the present invention exhibit higher increased middle point voltage of discharge and improved cycle life. It should be construed, however, that the nickel-metal hydride storage battery according to the present invention is not limited to those illustrated in the following examples, and various changes and modifications may be made within the scope of the invention.

### EXAMPLES

### Example 1

In Example 1, rare-earth elements La, Pr, and Nd as well as Zr, Mg, Ni, Al, and Co were mixed at a mole ratio of La:Pr:Nd:Zr:Mg:Ni:Al:Co=0.17:0.41:0.24:0.01:0.17:3.03:0.17:0.10, and the mixture was melted by high frequency induction melting and thereafter cooled. Thus, an ingot of a hydrogen-absorbing alloy was prepared.

Then, the resultant hydrogen-absorbing alloy ingot was annealed at a temperature of 950° C. in an argon atmosphere and was pulverized using a mortar in an argon atmosphere. The resultant powder was classified using a sieve. Thus, hydrogen-absorbing alloy powder was obtained which had a particle size of from 25 μm to 75 μm. The composition of the hydrogen-absorbing alloy powder was La_{0.17}Pr_{0.41}Nd_{0.24}Zr_{0.01}Mg_{0.17}Ni_{3.03}Al_{0.17}Co_{0.10}.

The hydrogen-absorbing alloy powder thus prepared was subjected to X-ray diffraction analysis with the use of an X-ray diffraction analyzer using Cu-Kα radiation as an X-ray source (RINT2000 system, made by Rigaku Corp.) at a scan speed of 2°/min. and a scan step of 0.02° in a scan range of 2θ° to 80°, to determine the intensity ratio I_{A}/I_{B}, which is a ratio between the strongest peak intensity I_{A} appearing in the range 2θ=30° to 34° and the strongest peak intensity I_{B} appearing in the range 2θ=40° to 44°. The hydrogen-absorbing alloy powder had an intensity ratio I_{A}/I_{B} of 0.76, and showed a crystal structure different from the CaCu₅ crystal structure.

Next, 0.5 parts by weight of CoO as well as 0.5 parts by weight of polyethylene oxide and 0.6 parts by weight of polyvinyl pyrrolidone as binder agents were added to 100 parts by weight of the foregoing hydrogen-absorbing alloy powder, and these were mixed to prepare a slurry. The resultant slurry was uniformly applied onto both sides of a punched metal conductive core that was plated with nickel, then dried and pressed. The resultant was cut into predetermined dimensions, and a hydrogen-absorbing alloy electrode to be used as the negative electrode was thus prepared.

Meanwhile, to prepare a positive electrode, 100 parts by weight of nickel hydroxide was mixed with 0.1 parts by weight of hydroxypropylcellulose as a binder agent added thereto to prepare a slurry. This slurry was filled into a nickel foam, which was then dried and pressed. Thereafter, the resultant was cut into predetermined dimensions. Thus, a positive electrode composed of a non-sintered nickel electrode was prepared.

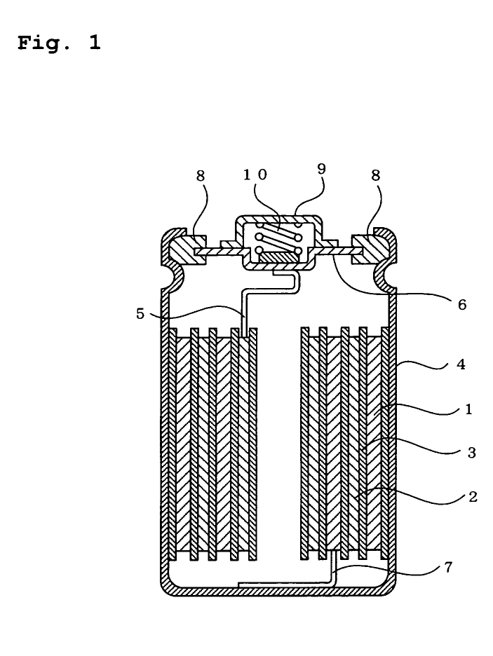

A nonwoven fabric made of polypropylene was used as a separator. An alkaline electrolyte solution used was an alkaline aqueous solution containing KOH, NaOH, and LiOH—H₂O at a weight ratio of 10:1:2 in a quantity of 30 weight %. Using these components, a cylindrical nickel-metal hydride storage battery as illustrated in FIG. 1, which had a design capacity of 2100 mAh, was fabricated.

The nickel-metal hydride storage battery of Example 1 was fabricated in the following manner. A positive electrode 1 and a negative electrode 2 were spirally coiled with a separator 3 interposed therebetween, as illustrated in FIG. 1, and these were accommodated in a battery can 4. Then, 2.4 g of the alkaline electrolyte solution was poured into the battery can 4. Thereafter, an insulative packing 8 was placed between the battery can 4 and a positive electrode cap 6, and the battery can 4 was sealed. The positive electrode 1 was connected to the positive electrode cap 6 by a positive electrode lead 5, and the negative electrode 2 was connected to the battery can 4 by a negative electrode lead 7. The battery can 4 and the positive electrode cap 6 were electrically insulated by the insulative packing 8. A coil spring 10 was placed between the positive electrode cap 6 and a positive electrode external terminal 9. The coil spring 10 can be compressed to release gas from the interior of the battery to the atmosphere when the internal pressure of the battery unusually increases.

### Example 2

In Example 2, a nickel-metal hydride storage battery was fabricated in the same manner as in Example 1, except that 1.0 part by weight of CoO was added to 100 parts by weight of the same hydrogen-absorbing alloy powder as that of Example 1 when preparing a hydrogen-absorbing alloy electrode used as the negative electrode.

### Example 3

In Example 3, a nickel-metal hydride storage battery was fabricated in the same manner as in Example 1, except that, in place of CoO, 0.5 parts by weight of Co(OH)₂ was added to 100 parts by weight of the same hydrogen-absorbing alloy powder as that of Example 1 when preparing a hydrogen-absorbing alloy electrode used as the negative electrode.

### Comparative Example 1

In Comparative Example 1, a nickel-metal hydride storage battery was fabricated in the same manner as in Example 1, except that no CoO was added to 100 parts by weight of the same hydrogen-absorbing alloy powder as that of Example 1 when preparing a hydrogen-absorbing alloy electrode used as the negative electrode.

### Comparative Example 2

In Comparative Example 2, a nickel-metal hydride storage battery was fabricated in the same manner as in Example 1, except that, in place of CoO, 0.5 parts by weight of Co was added to 100 parts by weight of the same hydrogen-absorbing alloy powder as that of Example 1 when preparing a hydrogen-absorbing alloy electrode used as the negative electrode.

Next, the nickel-metal hydride storage batteries of Examples 1 to 3 and Comparative Examples 1 and 2 were charged at a current of 210 mA for 16 hours and thereafter discharged at a current of 420 mA until the battery voltage became 1.0 V to activate the nickel-metal hydride storage batteries.

Then, the cycle life of each of the nickel-metal hydride storage batteries of Examples 1 to 3 and Comparative Examples 1 and 2 was obtained in the following manner. Each of the nickel-metal hydride storage batteries of Examples 1 to 3 and Comparative Examples 1 and 2, activated in the above-described way, was charged at a current of 2100 mA. After the battery voltage reached the maximum value, each of the batteries was further charged until the voltage lowered by 10 mV, and was then set aside for 1 hour. Thereafter, each of the nickel-metal hydride storage batteries was discharged at a current of 2100 mA until the battery voltage became 1.0 V, and was then set aside for 1 hour. This charge-discharge cycle was repeated until the discharge capacity of each of the nickel-metal hydride storage batteries lowered to 60% of the discharge capacity at the first cycle, to obtain the number of cycles for each of the batteries. Then, the cycle life of each of the nickel-metal hydride storage batteries was determined using relative indices wherein the cycle number of the alkaline storage battery of Comparative Example 1 was taken as 100. The results are shown in Table 1 below.

In addition, the middle point voltage of discharge of each of the nickel-metal hydride storage batteries of Examples 1 to 3 and Comparative Examples 1 and 2 was measured at the time when the charge-discharge cycle was repeated 100 times. The results are also shown in Table 1 below.

TABLE 1

| | | | | Middle |
|---|---|---|---|---|
| | Additive to negative | | | point |
| | electrode | | | voltage of |
| | | Amount added to | | discharge |
| | Additive | alloy | Cycle life | (V) |
| Ex. 1 | CoO | 0.5 wt. % | 113 | 1.138 |
| Ex. 2 | CoO | 1.0 wt. % | 126 | 1.150 |
| Ex. 3 | Co(OH)₂ | 0.5 wt. % | 109 | 1.130 |
| Comp. Ex. 1 | — | — | 100 | 1.123 |
| Comp. Ex. 2 | Co | 0.5 wt. % | 89 | 1.103 |

The results demonstrate that the nickel-metal hydride storage batteries of Examples 1 to 3, in which a cobalt compound such as CoO or Co(OH)₂ was added to the negative electrode using the hydrogen-absorbing alloy, exhibited greater cycle life and at the same time higher middle point voltage of discharge than the nickel-metal hydride storage batteries of Comparative Example 1, in which no cobalt compound was added, and Comparative Example 2, in which cobalt was added. Note that the hydrogen-absorbing alloy used for the batteries had an intensity ratio I_{A}/I_{B} of 0.1 or greater as determined by X-ray diffraction analysis using Cu-Kα radiation as an X-ray source, where I_{A} is the strongest peak intensity that appears in the range of 2θ=30° to 34° and I_{B} is the strongest peak intensity that appears in the range of 2θ=40° to 44°.

Moreover, a comparison between the nickel-metal hydride storage batteries of Examples 1 and 2 proves that the cycle life and middle point voltage of discharge further improved when the amount of the cobalt compound CoO added was greater.

Furthermore, a comparison between the nickel-metal hydride storage batteries of Examples 1 and 3 proves that the nickel-metal hydride storage battery of Example 1, in which CoO was added as the cobalt compound, exhibited greater cycle life and a higher middle point voltage of discharge than the nickel-metal hydride storage battery of Example 3, in which Co(OH)₂ was added as the cobalt compound. It is believed that this is because CoO is greater in terms of the weight proportion of the cobalt contained in the cobalt compound.

In addition, the nickel-metal hydride storage batteries of Example 1 and Comparative Example 1 were disassembled after the charge-discharge cycle was repeated 100 times, and the negative electrodes were taken out to measure the oxygen concentration in each of the hydrogen-absorbing alloys and the alkaline electrolyte solution holding capacity of the separators. The results are shown in Table 2 below.

In Table 2, the oxygen concentrations in the hydrogen-absorbing alloys are represented as relative indices wherein the oxygen concentration in the hydrogen-absorbing alloy used in the nickel-metal hydride storage battery of Comparative Example 1 is taken as 100. The alkaline electrolyte solution holding capacities were obtained as follows. In each of the nickel-metal hydride batteries, the proportion of the alkaline electrolyte solution retained in the separator was determined with respect to the total amount of the alkaline electrolyte solution retained in the battery. The values thus obtained are shown as alkaline electrolyte solution holding capacities (%)

TABLE 2

| | Oxygen | Alkaline electrolyte solution |
|---|---|---|
| | concentration | holding capacity of separator |
| Ex. 1 | 100 | 6.4 wt. % |
| Comp. Ex. 1 | 100 | 6.3 wt. % |

As a consequence, almost the same results were obtained for the nickel-metal hydride storage battery of Example 1, in which a cobalt compound CoO was added to the negative electrode, and the nickel-metal hydride storage battery of Comparative Example 1, in which no cobalt compound CoO was added to the negative electrode, in terms of oxygen concentration in the hydrogen-absorbing alloy and the alkaline electrolyte solution holding capacity of separator. This indicates that adding a cobalt compound to the negative electrode did not prevent the foregoing hydrogen-absorbing alloy from being oxidized or inhibit decreasing the alkaline electrolyte solution in the separator.

From the results, it is believed that the cycle life and the middle point voltage of discharge that were improved in the nickel-metal hydride storage batteries of each of the Examples, in which a cobalt compound was added to the negative electrode, were improved for the following reasons. As previously mentioned, by charging and discharging of the nickel-metal hydride storage battery, the foregoing cobalt compound dissolves into the alkaline electrolyte solution and quickly deposits on the surface of the hydrogen-absorbing alloy. This prevents the magnesium contained in the foregoing hydrogen-absorbing alloy from dissolving into the alkaline electrolyte solution, and inhibits the composition of the hydrogen-absorbing alloy from changing and the hydrogen-absorbing alloy from deteriorating. At the same time, the cobalt compound deposited on the surface of the hydrogen-absorbing alloy, which has high conductivity, serves to reduce the resistance in the negative electrode.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese Patent Application No. 2004-294407 filed Oct. 7, 2004, which is incorporated herein by reference.

What is claimed is:

1. A nickel-metal hydride storage battery comprising:
a positive electrode;
a negative electrode including a hydrogen-absorbing alloy; and
an alkaline electrolyte solution;
said hydrogen-absorbing alloy containing at least a rare-earth element, magnesium, nickel, and aluminum, and having an intensity ratio I_{A}/I_{of} 0.1 or greater as determined by X-ray diffraction analysis using Cu-Kα radiation as an X-ray source, where I_{A} is the strongest peak intensity that appears in the range of 2θ=30° to 34°, and I_{B} is the strongest peak intensity that appears in the range of 2θ=40° to 44°, and
said negative electrode containing a cobalt compound.

2. The nickel-metal hydride storage battery according to claim 1, wherein said cobalt compound is cobalt oxide and/or cobalt hydroxide.

3. The nickel-metal hydride storage battery according to claim 2, wherein said cobalt compound is cobalt oxide.

4. The nickel-metal hydride storage battery according to claim 1, wherein the amount of cobalt in said cobalt compound added to said negative electrode is within a range of from 0.3 weight % to 0.8 weight % with respect to the weight of said hydrogen-absorbing alloy.

5. The nickel-metal hydride storage battery according to claim 4, wherein said cobalt compound is cobalt oxide and/or cobalt hydroxide.

6. The nickel-metal hydride storage battery according to claim 5, wherein said cobalt compound is cobalt oxide.
